(19) United States
(12) Patent Application Publication
(10) Pub. No.: US 2007/0173197 A1
(43) Pub. Date: Jul. 26, 2007

(54) An Integrated Device Using Bluetooth Technology

(75) Inventor: Chen Kuo Hsiung, Kin Bay, KLN (HK)

Correspondence Address: JACK SHORE;MUCH SHELIST FREED DENENBERG AMENT&RUBENSTEIN,PC, 191 N. WACKER DRIVE, SUITE 1800, CHICAGO, IL, 60606-1615, US

(73) Assignee: Silicon Pyramid Electron Ltd., Guangzhou (CN)

(21) Appl. No.: 11/382,607

(22) Filed: May 10, 2006

(30) Foreign Application Priority Data
Jan. 20, 2006 (CN) 200620054306.6

(51) Int. Cl. H04H 7/00

(52) U.S. Cl. 455/3.06

(57) ABSTRACT

This invention comprises an integrated device using bluetooth transmission technology. It is composed of a case having a compartment for a music player and a compartment for an audio dongle with the audio input located on the audio dongle and a bluetooth transmitter and receiver located inside. Each of the compartments are also covered. The panel of the said case is also equipped with control buttons. This novel integrated device will effectively prevent a music player and audio dongle from damage caused by being accidentally hit or dropped against a hard surface while in use and the display of the music player can also be well protected from being shattered accidentally. This novel device is itself a remote control for the output terminal on the audio system, which can be used to remotely control the device at the other receiving end.

### CROSS REFERENCE TO RELATED APPLICATION

This application claims priority to Chinese Utility Application 200620054306.6 filed Jan. 20, 2006.

### TECHNICAL FIELDS

Applicant's novel invention relates to the bluetooth transmission technology, particularly an integrated device using bluetooth technology.

### BACKGROUND TECHNOLOGIES

The bluetooth transmitters for existing portable music players, such as iPod players, MP3 players and walkmans, are usually equipped with dongles to enable the transmission of the audio signals through bluetooth technology. The dongle also features an audio plug which can be plugged into the headphone jack on the music player. FIG. 1 is a structural diagram showing how an iPod player and a bluetooth dongle are connected with each other. The audio plug of the bluetooth dongle can be plugged into the headphone jack on the iPod player, through which audio signals are digitized and transmitted wirelessly using Bluetooth technology to the other receiving end, such as, an earphone or a loudspeaker. At present, the dongle is primarily concerned with the transmission of audio signals.

### DESCRIPTION OF INVENTION

The purpose of this invention is to provide a bluetooth dongle which can be used for the transmission an reception of audio signals and also as a remote controller to control the audio-output device.

Applicant's novel invention is achieved by providing an integrated bluetooth-enabled device characterized by an assembly that includes a case having two compartments for accommodating a music player and an audio dongle respectively.

The audio dongle has an audio input on it, and the audio dongle is equipped with a bluetooth transmitter and receiver.

The front view of the said case is also equipped with control buttons.

The audio dongle has a USB port.

The audio dongle carries in it a built-in rechargeable battery.

The music player can be either an iPod player or a MP3 player.

There are compartment covers provided to fit over the compartment openings.

The compartments for accommodating the respective music player and audio dongle are isolated.

A hole is located between the wall isolating the compartments for accommodating the music player and the audio dongle.

Applicant's novel assembly is superior to the existing technologies in that since a music player is kept inside a case the case will effectively prevent the music player from getting damaged caused by being accidentally hit or dropped against a hard surface while in use. In addition, the display of the music player can also be better protected from being shattered accidentally. Applicant's novel assembly is itself also a remote control for the output terminal on the audio system, which can be used to remotely control the device at the other receiving end., i.e., any audio input devices, such as earphones or loudspeakers. The assembly is a compact product, which was designed with both aesthetics and convenient use in mind. It also effectively prevents the loss of the dongle, or the dongle from coming loose due to it not having been properly plugged into a headphone jack. The novel assembly also provides for a type of dongle that can transmit and receive audio signals through bluetooth technology. The novel assembly allows the built-in battery to be recharged via a USB connection, or the battery can be removed from the case for direct recharging. Also, the novel assembly allows the iPod products to be recharged via a USB connection. Furthermore, the novel assembly is compatible with any audio-output equipment, such as, earphones and loudspeakers.

### ATTACHED FIGURES

FIG. 1 shows the structure of an existing product;

FIG. 2 shows the structure of Applicant's novel assembly;

FIG. 3 shows the front view of the assembly of FIG. 2 in an open position;

FIG. 4 shows the back view of the assembly of FIG. 2 in an open position.

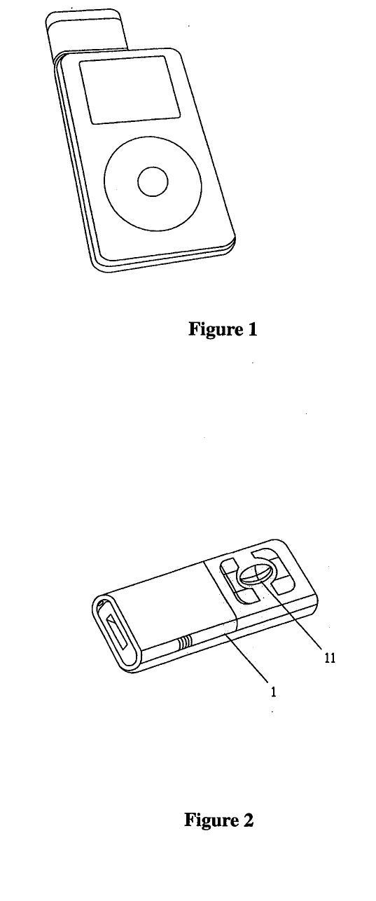

### IMPLEMENTATION DETAILS

Applicant's novel invention will be exemplified and illustrated in more detail below.

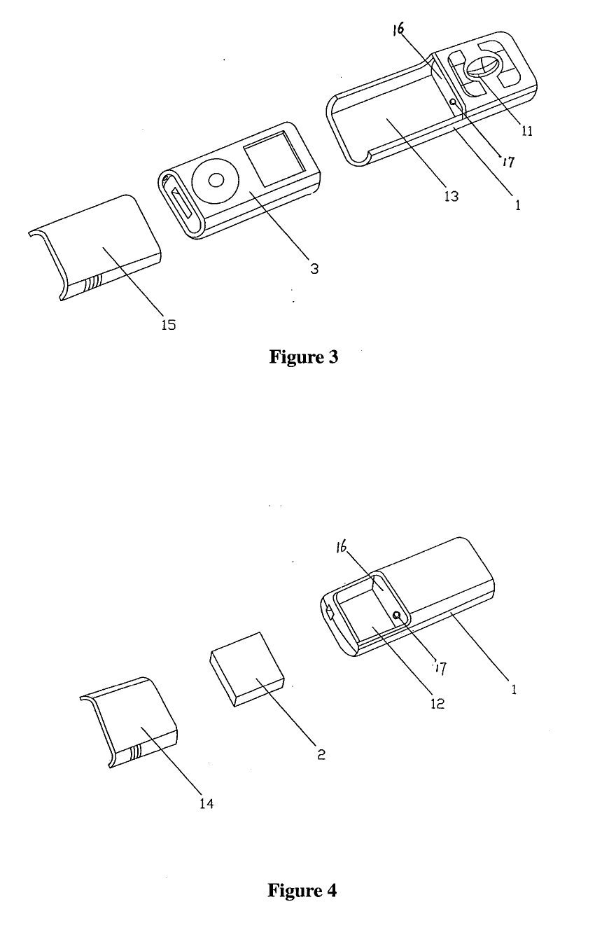

As show on in FIGS. 2 to 4, the bluetooth-enabled device consists of a case 1 and audio dongle 2. The front view of the case 1 features a compartment 13 to accommodate music player 3. The back view of case 1 features compartment 12 that accommodates the audio dongle 2. Control buttons 11 are located on the front view of case 1. Audio input and USB port are located on audio dongle 2 and audio dongle 2 is equipped with a built-in bluetooth transmitter and receiver, and a rechargeable battery. The music player 3 can be either an iPod player or MP3 player. Compartment 12 and Compartment 13 are isolated from each other and wall 16 that separates these two compartments, includes hole 17. The audio input on the audio dongle is connected to music player, player 3 via hole 17.

When using the bluetooth-enabled device, the user is required to open cover 14 of compartment 12 from the back of case 1 in order to fit Music Player audio dongle 2 into it, and then close compartment 12 with cover 14. The next step is to open cover 15 of compartment 13 located on the front of case 1 so as to accommodate music player 3 (such as an iPod) and then close compartment 13 with cover 15. When the device is switched on, the bluetooth transmission (stereo) function will be activated. The audio output of the receiving end (such as the earphones and loudspeaker could be controlled remotely through using control buttons 11 located on the front panel of case 1. Control buttons 11 includes volume control and power on/off buttons.

The audio dongle 2 of this novel assembly can be connected with a computer or other devices using a USB connection. Through this method, audio dongle 2, having the bluetooth transmitter and receiver built inside, can transmit the audio signals from the computer wireless to other bluetooth-enabled devices.

Above is an example of implementation of applicant's novel invention, but application's invention is not limited to the above implementation example. Other modifications, decorations, substitutions, combinations and simplifications that fall within the true spirit and scope of the attached claims are covered thereby.

1. An integrated device using bluetooth technology comprising a case defining a plurality of separate compartments which contains a compartment for accommodating a music player and another one for accommodating an audio dongle and covers for such compartments.

2. An integrated device in accordance with claim 1 in which the audio dongle includes an audio input and a built-in bluetooth transmitter and receiver.

3. An integrated device in accordance with claim 1 in which the case includes control buttons thereon.

4. An integrated device in accordance with claim 1 in which the audio dongle includes a USB port.

5. An integrated device in accordance with claim 1 in which the audio dongle includes a built-in rechargeable battery.

6. An integrated device in accordance with claim 1 in which the music player comprises an iPod.

7. An integrated device in accordance with claim 1 in which the music player comprises an MP3 player.

8. An integrated device in accordance with claim 1 including a wall separating the two compartments.

9. An integrated device in accordance with claim 8 in which there is provided a hole in the wall separating the two compartments whereby the audio dongle and music player can be connected.
